(19) United States
(12) Patent Application Publication
(10) Pub. No.: US 2025/0123376 A1
(43) Pub. Date: Apr. 17, 2025

(54) ToF SYSTEM, CONTROL METHOD THEREOF, COMPUTER READABLE RECORDING MEDIUM, AND ToF APPARATUS

(71) Applicant: NIPPON CHEMI-CON CORPORATION, Tokyo (JP)

(72) Inventors: Katsuya Tamaki, Tokyo (JP); Ryo Sato, Tokyo (JP); Naohisa Shibata, Tokyo (JP)

(73) Assignee: NIPPON CHEMI-CON CORPORATION, Tokyo (JP)

(21) Appl. No.: 18/904,216

(22) Filed: Oct. 2, 2024

(30) Foreign Application Priority Data
Oct. 16, 2023 (JP) 2023-178176

(51) Int. Cl. G01S 7/4915; G01S 7/4912; G01S 7/4914; G01S 17/32

(52) U.S. Cl. CPC G01S 7/4915; G01S 7/4914; G01S 7/4918; G01S 17/32

(57) ABSTRACT

A ToF system is configured to apply light to an object and find distance information by receiving reflected light from the object. The ToF system includes a light source portion configured to apply the light to the object; a light receiver configured to receive the reflected light from the object; an information processing unit configured to acquire signal amount information from a received light output of the light receiver and calculate light amount information for making the signal amount information arise at a predetermined value or within a predetermined range of a lower limit threshold to an upper limit threshold; and a light amount control part configured to control a light amount of the light source portion using the light amount information.

### CROSS-REFERENCE TO RELATED APPLICATIONS

This application is entitled to the benefit of priority of Japanese Patent Application No. 2023-178176, filed on Oct. 16, 2023, the contents of which are hereby incorporated by reference.

### BACKGROUND

### Technical Field

A present disclosure relates to a light amount control according to received light information of reflected light from an object in a Time-of-Flight (ToF) system used for a measurement of a distance to the object, etc., for example.

### Description of the Related Art

A ToF system applies light to an object, receives reflected light from the object by a light receiver, and calculates distance information of the object from signal amount information acquired in the light receiver. It is known that accuracy of the distance information may be influenced by the light amount of light emitting means for applying light to the object.

As to the light amount of the light emitting means, in order to adjust the light amount of the light emitting means, it is known that an optimal pattern is chosen from the combination of the distance information based on the gestures of the object and the light amount to adjust the light amount of the light emitting means (for example, Japanese Unexamined Patent Application Publication No. 2011-179997).

### SUMMARY

By the way, a received light output of the light receiver receiving the reflected light from the object may fall a saturated state or a low signal-to-noise ratio state due to the received light amount of the reflected light, and proper signal amount information may not be acquired from the light receiver. The saturated state is generated when the received light amount of the reflected light is larger than necessary, and the low signal-to-noise ratio state is a state in which a noise level is high and a ratio of a signal representing the received light amount to a noise is small. Both states generate an error in the distance information, and the error rate of the distance information becomes large.

In order to avoid such phenomenon, an intensity adjustment of the reflected light received by the light receiver is required. In consideration of parameters, such as a distance to the object and reflectance of the object is required for the intensity of the reflected light. However, these parameters are governed by the setting circumstance of the ToF system or the like, and it is difficult to control them by the system.

The purpose of the present disclosure is to make a reflected light proper by controlling an amount of light applied to an object according to reflected light received from the object.

According to a first aspect of the present disclosure, a ToF system is configured to apply light to an object and find distance information by receiving reflected light from the object and includes a light source portion configured to apply the light to the object; a light receiver configured to receive the reflected light from the object; an information processing unit configured to acquire signal amount information from a received light output of the light receiver and calculate light amount information for making the signal amount information arise at a predetermined value or within a predetermined range of a lower limit threshold to an upper limit threshold; and a light amount control part configured to control a light amount of the light source portion using the light amount information.

According to a second aspect of the present disclosure, a control method of a ToF system configured to apply light to an object and find distance information by receiving reflected light from the object includes, by a light source portion, emitting the light and applying the light to the object; by a light receiver, receiving the reflected light of the object; by an information processing unit, acquiring signal amount information from a received light output of the light receiver and calculating light amount information for making the signal amount information arise at a predetermined value or within a predetermined range of a lower limit threshold to an upper limit threshold; and by a light amount control part, controlling a light amount of the light source portion using the light amount information.

According to a third aspect of the present disclosure, a computer readable recording medium stores a program for causing a computer to execute applying light to an object from a light source portion; acquiring signal amount information from a received light output of a light receiver receiving reflected light of the object and calculating light amount information for making the signal amount information arise at a predetermined value or within a predetermined range of a lower limit threshold to an upper limit threshold; controlling a light amount of the light source portion using the light amount information.

According to a fourth aspect of the present disclosure, a ToF apparatus is configured to apply light to an object and find distance information by receiving reflected light from the object, and includes a light source portion configured to apply the light to the object; a light receiver configured to receive the reflected light from the object; an information processing unit configured to acquire signal amount information from a received light output of the light receiver and calculate light amount information for making the signal amount information arise at a predetermined value or within a predetermined range of a lower limit threshold to an upper limit threshold; and a light amount control part configured to control a light amount of the light source portion using the light amount information.

### BRIEF DESCRIPTION OF THE DRAWINGS

FIG. 1 is a diagram illustrating a ToF system according to the first embodiment.

A of FIG. 2 is a diagram illustrating a received light output of a light receiver according to the second embodiment, and B of FIG. 2 is a diagram illustrating a pixel arrangement showing the received light output.

A of FIG. 3 is a diagram illustrating a pixel arrangement showing the received light output, and B of FIG. 3 is a diagram illustrating an average calculation of a signal amount.

A of FIG. 4 is a diagram illustrating a pixel arrangement and an object area for average, and B of FIG. 4 is a diagram illustrating object areas for average calculation.

FIG. 5 is a flow chart indicating a processing procedure of a ToF system.

FIG. 6 is a flow chart indicating a processing procedure of a ToF system according to the third embodiment.

FIG. 7 is a diagram illustrating an example of a light receiver according to an example.

FIG. 8 is a flow chart indicating a processing procedure of a receiving processing.

FIG. 9A to FIG. 9E are diagrams illustrating timing of operations of the receiving processing.

FIG. 10A is a diagram illustrating a case where a distance to an object is a short distance, FIG. 10B is a diagram illustrating a light emission period of a light emitter, FIG. 10C is a diagram illustrating a period of a short distance light receiving, and FIG. 10D is a diagram illustrating a period of a long distance light receiving.

FIG. 11A is a diagram illustrating a case where a distance to an object is a long distance, FIG. 11B is a diagram illustrating a light emission period of a light emitter, FIG. 11C is a diagram illustrating a period of a short distance light receiving, and FIG. 11D is a diagram illustrating a period of a long distance light receiving.

### DETAILED DESCRIPTION

### First Embodiment

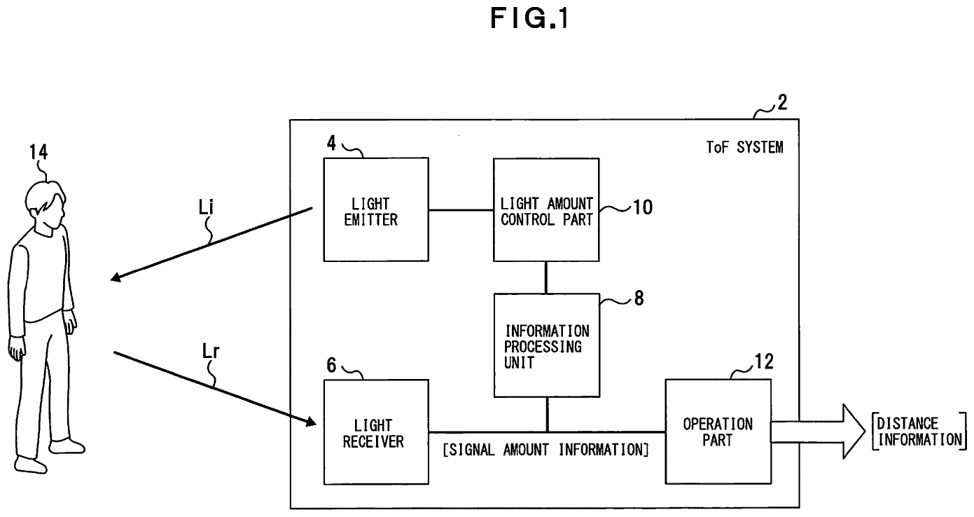

FIG. 1 illustrates a ToF system 2 according to the first embodiment of the present disclosure. A constitution shown in FIG. 1 is an example, and the present disclosure is not limited to this constitution.

The ToF system 2 shown in FIG. 1 includes a light emitter 4, a light receiver 6, an information processing unit 8 (hereinafter called “processing unit 8”), a light amount control part 10, and an operation part 12. The ToF system 2 acquires signal amount information from a received light output of the light receiver 6, controls a light amount of the light emitter 4 so that the signal amount information arises within a predetermined range of a lower limit threshold to an upper limit threshold, and makes distance information acquired by the operation part 12 proper. The light amount of the light emitter 4 that is a controlled object may be any of an emitted light amount, a diffusion amount, and a light amount (a flood light amount) on which the object 14 is floodlighted from the light emitter 4. The ToF system 2 is applied to a ToF camera module, a ToF camera, a distance measurement system, and the like that express contrast or coloring information representing the distance information to imaged image information.

The light emitter 4 is an example of a light source portion emitting light Li applied to the object 14. The light emitter 4 includes at least one light-emitting device or a plurality of light-emitting devices, emits light by control of the light amount control part 10, and applies the light Li to the object 14 (or floodlights the object 14 with the light Li). A light-emitting diode (LED) is used as the light-emitting device, for example. The object 14 is an object of which the distance information is acquired by acquiring the reflected light Lr, is an object on which the reflected light Lr produces, and may be any of a human, a thing, and the like, for example.

The light receiver 6 receives the reflected light Lr from the object 14 and produces a received light output. The received light output is an electrical signal representing the received light amount of the reflected light Lr. Light receiving means, such as a complementary metal-oxide semiconductor (CMOS) image sensor or a light receiving element that changes received light into an electrical signal is used as the light receiver 6, for example.

The processing unit 8 consists of a computer, includes a processor, a storage part such as a computer readable recording medium, etc., acquires the signal amount information of the reflected light Lr through receiving the received light output from the light receiver 6, and executes an information processing as a control operation for an optimization of the emitted light amount of the light emitter 4. The information processing includes a processing for calculating the light amount information for making a signal amount information arise at a predetermined value or within a predetermined range of the lower limit threshold to the upper limit threshold.

The light amount information calculated by the processing unit 8 in the information processing is fed back to the light amount control part 10 and is used for the light amount control of the light emitter 4 by the light amount control part 10.

The Light amount control part 10 controls the light amount of the light emitter 4 based on the light amount information fed back by the processing unit 8. The light amount of the light emitter 4 may be replaced with a flood light amount to the object 14. The computer that constitutes the processing unit 8 may be used for the light amount control part 10.

The operation part 12 acquires the signal amount information from the light receiver 6. As described above, the signal amount information is based on the light amount made proper by the light amount control of the light emitter 4 and is based on the reflected light Lr that the light receiver 6 is received. Consequently, the operation part 12 calculates the distance information representing the distance to the object 14 using the signal amount information made proper and outputs the distance information. The computer that constitutes the processing unit 8 may be used for the operation part 12. The information processing unit 8, the light amount control part 10, and the operation part 12 may be constituted using a plurality of computers.

### <Effect of First Embodiment>

According to the first embodiment, any of the following effects can be acquired.

(1) The light Li is applied to the object 14 from the light emitter 4, the light receiver 6 acquires the reflected light Lr from the object 14, and the received light output having a bit depth of [n] bits is acquired from the light receiver 6. Thus, the ToF system can calculate the distance information of the object 14 using the received light output of the light receiver 6.

(2) If the predetermined value or the predetermined range of the lower limit threshold LimL to the upper limit threshold LimU is set up to the signal amount information, the signal amount information can be controlled within the range of the LimL to LimU. Thus, according to the ToF system 2, the signal amount information acquired from the received light output of the light receiver 6 receiving the reflected light Lr arises within the predetermined range of the lower limit threshold to the upper limit threshold, and the received light output of the light receiver 6 is prevented from being a saturated state or a low signal-to-noise ratio state. As a result, High accuracy distance information can be acquired.

(3) The ToF system 2 can control the light amount of the light emitter 4 using the received light output according to sensitivity of the light receiver 6 to the received light, and the influence of the sensitivity of the light receiver 6 to the received light can be reduced to the distance information that is a result of an operation of the operation part 12.

(4) Since the information to be processed is made proper when the distance information of the object is calculated, the load intensity of an information processing can be reduced.

### Second Embodiment

The second embodiment calculates an average of all or some of signal amount information acquired from the received light output of the light receiver 6 and uses the average for light amount control of the light emitter 4. That is, in calculation of the average of the signal amount information, pixels of the full area of the signal amount information may be used, and pixels of a selected area may be extracted and used. Thus, the second embodiment includes form in which an average is calculated using all pixels of the signal amount information, form in which the pixels of the selected area that is a part of the signal amount information is extracted to calculate an average, form with control per frame, and the like.

### <Selected Area>

If the selected area is expressed by the image that is an aggregate of pixel data, the selected area is the signal amount information including all pixel data, and the number of the pixels constituting the selected area may be one (the minimum value) to n (the maximum value). For example, if the x, y coordinates are the signal amount information including pixel data of a certain area, the area of the “coordinates” as a selective parameter and the number of the area may be predetermined number. Furthermore, if the signal amount information is the signal amount information including pixel data of the certain area, a threshold of a “signal amount information threshold” as the selective parameter or a threshold range may be predetermined number.

### <Range of Average (Ave (α)) of Signal Amount Information>

When the amount of electric current flowing into the light-emitting device constituting the light emitter 4 is set to α, the average of the signal amount information is set to Ave (α), and the LimL and LimU as described above are set for Ave (α), the range of Ave (α) can be expressed by formula 1.

$$LimL \leq Ave ( α ) \leq LimU \qquad Formula 1$$

If the electric current amount α is controlled to satisfy formula 1, the light amount of the light emitter 4 (that is, the signal amount information) can be made proper. Hereinafter, the average of the signal amount information is expressed as Ave (α).

### <Acquisition Range of Average Ave (α)>

When the light receiver 6 is equipped with a sensor having screen resolution of, for example, quarter video graphics array (QVGA) (320×240 pixels), an output information of the light receiver 6 serves as a pixel arrangement from the first pixel (0, 0) to the 76800th pixel (320, 240). The pixel arrangement is input into the processing unit 8 in a single row.

The processing unit 8 executes any of the first form in which the average of all the pixels (320×240 pixels=76800 pixels) is calculated and compared with the LimL and LimU or the second form in which a part of all the pixels is extracted, and the average of the part of all the pixels is calculated and compared with the LimL and LimU. At the second form, it is possible to compare the average calculated from pixels (for example, 30×30 pixels=900 pixels) of the selected area in all the pixels with the LimL and LimU.

### <Received Light Output of Light Receiver 6 and Pixels>

A of FIG. 2 illustrates the pixel arrangement that is the received light output of the light receiver 6 according to the second embodiment.

The received light output of the light receiver 6 (that is, the signal amount information acquired from the light receiver 6) is an aggregate of all the pixels in the frame F as a unit as shown in A of FIG. 2, and all the pixels are constituted from the first pixel (0, 0) to the nth pixel (ny, nx), as described above. An arrow in figure shows an output order of the pixel arrangement. Each pixel includes the signal amount that individually represents a shade or a luminance according to the reflected light Lr.

B of FIG. 2 illustrates the pixel arrangement showing all the pixels. The received light output of the light receiver 6 is pixel information of the first pixel (0, 0), the second pixel (0, 1), . . . , and the nth pixel (ny, nx), as shown in B of FIG. 2, and the pixel information of the pixels are arranged in series and is output in the pixel arrangement. The received light output that consists of the pixel arrangement is input into the processing unit 8 one by one in series.

### <Case of All Pixels as Objects>

A and B of FIG. 3 illustrate a processing of an average calculation for all the pixels as objects.

When all the pixels are the objects for the average calculation, all the pixels in one frame (F) output from the light receiver 6 are objects, as shown in A of FIG. 3.

The processing unit 8 calculates the average using all the pixels consisting of the first pixel (0, 0), the second pixel (0, 1), . . . , and the nth pixel (ny, nx) and compares the average with the LimU and LimL, as shown in B of FIG. 3.

### <Case of Selected Pixels of All Pixels as Objects>

A of FIG. 4 illustrates the case where selected pixels of all the pixels output from the light receiver 6 in a time series are set as average objects. For example, in the processing unit 8, areas A1, A2, A3, . . . in which pixels are periodically extracted from the pixels output from the light receiver 6 in a time series are set in this case, as shown in A of FIG. 4. Each of the areas A1, A2, A3, . . . includes, for example, three pixels, and an average of signal amounts of pixels included in the areas A1, A2, A3, . . . is calculated.

When the selected pixels of all the pixels are set as objects, as shown in B of FIG. 4, the processing unit 8 acquires all the pixels output from the light receiver 6, periodically acquires, for example, three pixels included in each of the areas A1, A2, A3, . . . from all the pixels according to a certain rule, calculates the average of the signal amounts of the pixels included in the areas A1, A2, A3, . . . , and compares the average with the LimU and LimL.

According to such a process, an information amount treated in the information processing executed by the processing unit 8 can be reduced and speeding up of the processing and a load to the computer can be reduced.

<Comparison of Ave (α) with LimL and LimU Each Frame>

As to the objects of which the average is calculated, frames of which averages are calculated from the output information of the light receiver 6 may be controlled. When the light receiver 6 includes a sensor that is able to draw, for example, 30 sheets per second, the processing unit 8 may calculate the Ave (α) from pixels of each frame and may compare the Ave (α) with the LimU and LimL. If this compare result is used, light amount information is acquired 30 times per second from the processing unit 8 to the light amount control part 10. According to such a processing, it excels in a following property.

Moreover, The Ave (α) may be calculated from the pixels every 30 frames, this Ave (α) may be compared with the LimU and LimL. If this compare result is used, light amount information is acquired one time per second from the processing unit 8 to the light amount control part 10. According to such a processing, it excels in a noise resistance. Thus, a proper setup is attained to a light amount applied to the object 14.

<Relationship between Property of Object 14 and Light Amount Control>

when treating an average of all pixels in case where reflectivity of a central part of the object 14, which is a distance measurement object, is remarkable high and reflectivity of a perimeter of the object 14 is remarkable low, the relationship between a central part and a perimeter part of an image is expressed as the number of strong pixels«the number of weak pixels, where the strong pixel is a pixel of which a light amount is large and the weak pixel is a pixel of which a light amount is small. Thus, since the average of signal amount information is small value in this case, processing for increasing the amount of electric current into the light emitter 4 is executed. As a result, while the whole image of the object 14 becomes bright, a part in which reflectivity is high will be saturated.

On the other hand, when a part having high reflectivity in the object 14 is set as the selected area and the average of the signal amount information is calculated, the relationship between the central part and the perimeter part is reversed and is expressed as the number of strong pixels»the Number of weak pixels. Since the average of the signal amount information is large value in this case, processing for decreasing the amount of electric current into the light emitter 4 is executed. As a result, a tendency that the proper signal amount is acquired from a high reflectivity part of the object 14 is acquired.

### <Processing Procedure of ToF System 2>

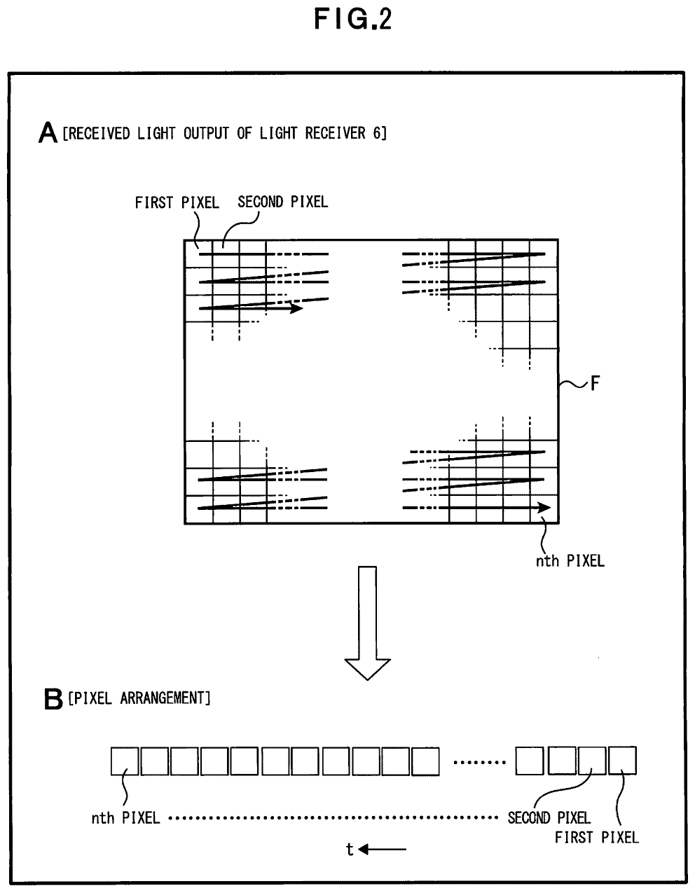

FIG. 5 illustrates a processing procedure of a light amount control used average of luminance values of the reflected light Lr. The processing procedure is an example of a control method of the ToF system or a ToF apparatus of the present disclosure, or a program thereof.

The processing procedure is an information processing executed mainly by the processing unit 8. The processing procedure includes an acquisition processing (process F11) of the signal amount information of the reflected light Lr and a calculation processing (process F12) of the light amount information. Process F12 constitutes a part of process F11. In process F12, an average of an amount of a received light signal is calculated from the luminance values included in the received light output of the light receiver 6, and the light amount information used for the light amount control of the light emitter 4 is increased or decreased.

Process F11 includes setting an initial value of a light amount (S101), controlling the light amount (S102), emitting light by the light emitter 4 (S103), receiving the reflected light Lr (S104), frame output of the light receiver 6 (S105), frame input into the processing unit 8 (S106), extracting the selected areas (S107), process F12 (S108), outputting the signal amount information (S109), and the like.

Setting an initial value of a light amount (S101): In advance of a starting of operation of the ToF system 2, the processing unit 8 sets an initial value of the light amount to the light emitter 4.

Controlling the light amount (S102): The processing unit 8 controls the light amount of the light emitter 4 by the light amount control part 10. The light amount information acquired in process F12 is used for the light amount control.

Emitting light by the light emitter 4 (S103): The light emitter 4 emits light by control of the light amount control part 10, and the light amount of the light emitter 4 is controlled by the light amount information acquired in process F12.

Receiving the reflected light Lr (S104): The light Li is applied to the object 14 by emission of the light emitter 4. Thereby, the reflected light Lr from the object 14 is acquired, the light receiver 6 receives the reflected light Lr, and the received light output is acquired in the light receiver 6.

Frame output of the light receiver 6 (S105): As described above, the CMOS image sensor is used as the light receiver 6. Thus, in the light receiver 6, the frame output that is an aggregate of the pixels (that is, received light output) is acquired.

Frame input into the processing unit 8 (S106): The frame output acquired in the light receiver 6 is provided for the processing unit 8. This is frame input into the processing unit 8 from the light receiver 6.

Extracting the selected area (S107): The processing unit 8 extracts the selected areas including object pixels for an average from all the pixels included in the provided frame.

Process F12 (S108): In process F12 (S108), a comparison processing of all groups is executed based on comparison of each of groups classified from all the pixels, and the signal amount information is output. Descriptions of process F12 (S108) is mentioned later.

Outputting the signal amount information (S109): The processing unit 8 outputs the signal amount information after process F12 (S108), and the light amount control part 10 acquires the signal amount information.

Thus, the light amount control part 10 acquires the light amount information from the processing unit 8, and the light amount of the light emitter 4 is made proper by the light amount information. In this embodiment, the light amount of the light emitter 4 is controlled so that the luminance values of the reflected light Lr falls within a range of the LimL to LimU.

### <Processing in Process F12 (S108)>

Process F12 includes calculating an average of the luminance values (e.g., Ave (α) as described above) (S201), comparing the average with the upper limit threshold (e.g., LimU as described above) (S202), comparing the average with the lower limit threshold (e.g., LimL as described above) (S203), decrementing the light amount value (S204), incrementing the light amount value (S205), outputting the light amount information (S206), and the like. A light amount register of the processing unit 8 is used for process F12, the light amount register includes an upper limit register and a lower limit register, the upper limit register reduces the light amount when the pixels in which the average is greater than the upper limit threshold are detected, and the lower limit register increases the light amount when the pixels in which the average is less than the lower limit threshold are detected.

Calculating the average of the luminance values (S201): The processing unit 8 acquires the luminance values of the pixels in the selected areas and calculates the average of the luminance values.

Comparing the average with the upper limit threshold (S202): The processing unit 8 compares the average of the luminance values with the upper limit threshold and determines whether the average is the upper limit threshold or less (hereinafter “the average≤the upper limit threshold”). When the average≤the upper limit threshold (YES of S202), it proceeds to S203, and when the average>the upper limit threshold (NO of S202), it proceeds to S204.

Comparing the average with the lower limit threshold (S203): When the average≤the upper limit threshold (YES of S202), the processing unit 8 determines whether the average≥the lower limit threshold. When the average≥the lower limit threshold (YES of S203), the processing unit 8 ends process F12 and it proceeds to S109, and when the average<the lower limit threshold (NO of S203), it proceeds to S205.

Decrementing the light amount value (S204): When the average>the upper limit threshold (NO of S202), the average is large and out of proper range, and the processing unit 8 decrements the light amount value and reduces the light amount.

Incrementing the light amount value (S205): When the average<the lower limit threshold (NO of S203), the average is small and out of proper range, and the processing unit 8 increments the light amount value and increases the light amount.

Outputting the light amount information (S206): After processing of S204 or S205, the processing unit 8 outputs and provides the adjusted light amount information for the light amount control part 10.

<Groups Classified from All Pixels>

If the groups classified from all the pixels are expressed by the image that is the aggregate of the pixel data, the groups represent the pixel groups classified in conformity with specific case classification. For example, group is formed from (i) a classification with all pixel data, (ii) a classification with electricity Q11 data and electricity Q12 data that represent pixels described later, (iii) a classification with data included in the selected area described above, or the like.

### <Effect of Second Embodiment>

According to the second embodiment, any of the following effects can be acquired.

(1) Since the average of all or a part of the signal amount information that is the received light output acquired in the light receiver 6 with the reflected light Lr from the object 14 is compared with the lower limit threshold or the upper limit threshold as predetermined value to generate the light amount information and control the light amount of the light emitter 4, the amount of the light applied to the object 14 can be made proper, and high-accuracy distance information can be calculated.

(2) A specific object area or an object frame can be selected from pixels that represent the received light output of the light receiver 6, the average of the signal amount information can be calculated, and the average can be compared with the lower limit threshold or the upper limit threshold as predetermined value to generate the light amount information and control the light amount of the light emitter 4. Consequently, the amount of the light applied to the object 14 can be made proper, and high-accuracy distance information can be calculated.

### Third Embodiment

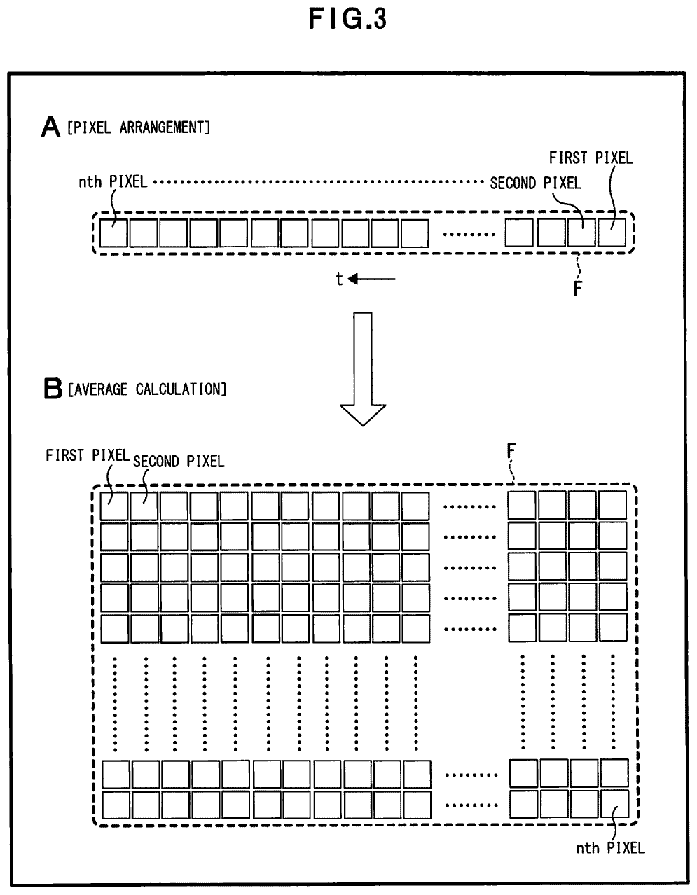

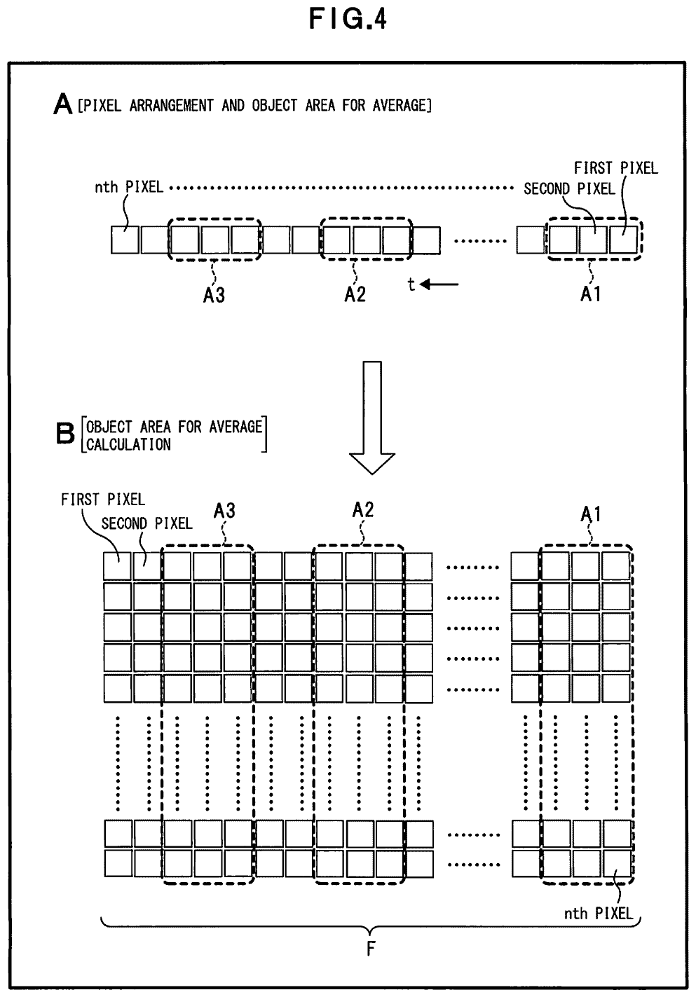

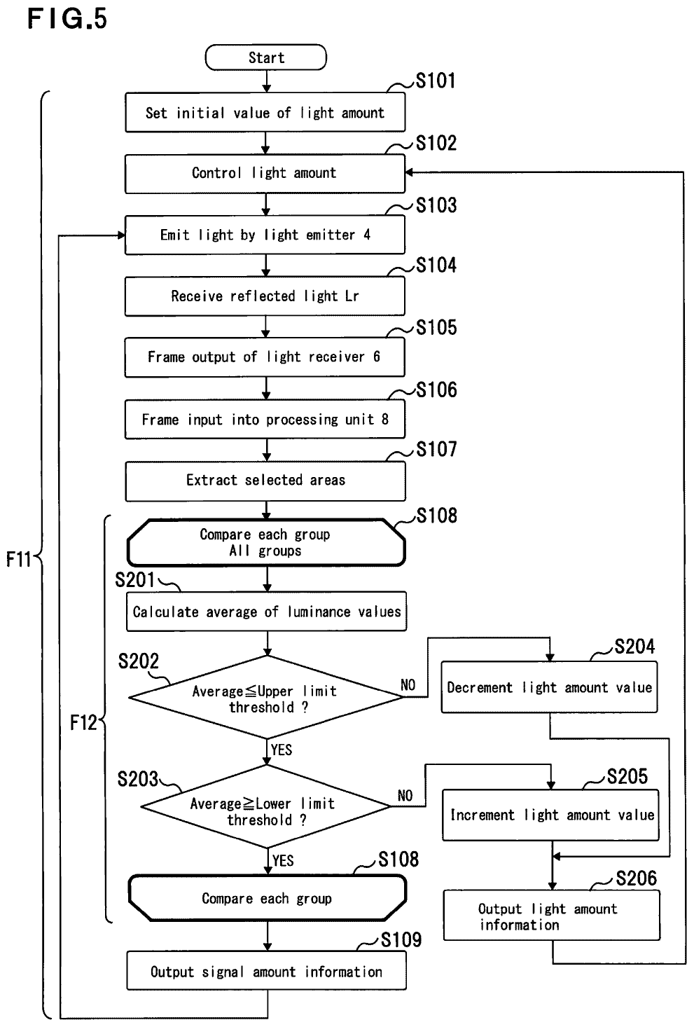

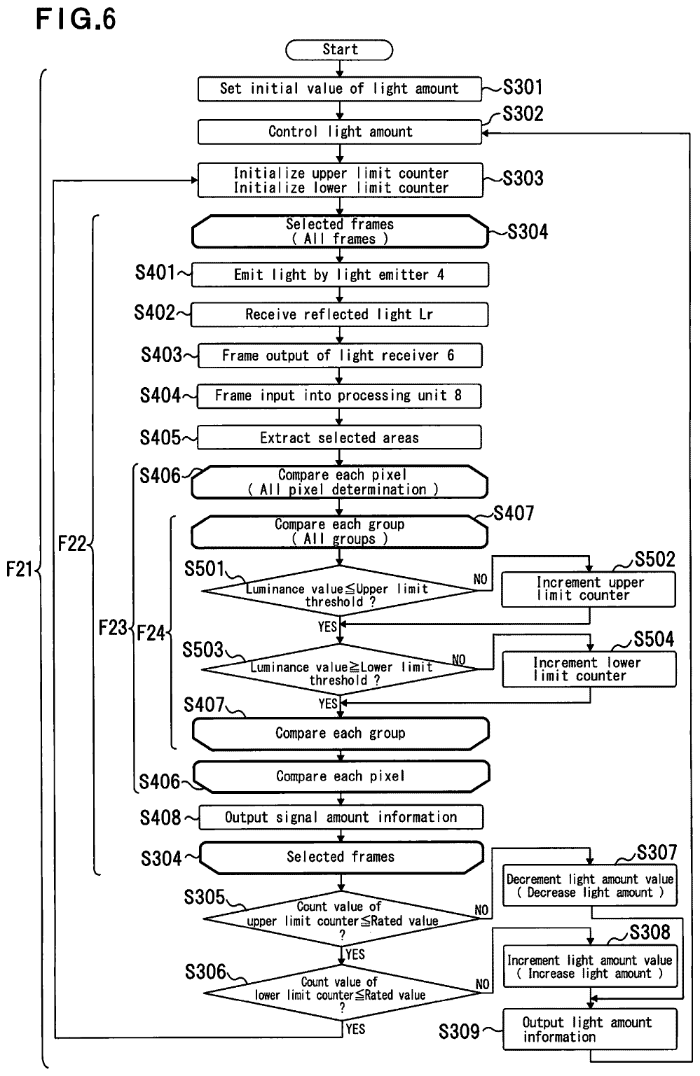

FIG. 6 illustrates a processing procedure in case where a counter is used for an optimization of the luminance values acquired from the reflected light Lr. The processing procedure is an example of a control method of the ToF system or the ToF apparatus of the present disclosure or an example of program thereof. In the processing procedure, an upper limit counter that counts pixels of which luminance values exceed the upper limit threshold and a lower limit counter that counts pixels of which luminance values are lower than the lower limit threshold are set to a counter.

The processing procedure relates to an information processing that is mainly executed by the processing unit 8 in the same way as the second embodiment. The processing procedure includes an acquisition processing of the signal amount information of the reflected light Lr (process F21), an acquisition processing of the selected frames (process F22), a comparison processing of each pixel (process F23), and a comparison processing of each group (process F24).

Process F21 includes setting an initial value of the light amount (S301), controlling the light amount (S302), initializing the upper limit counter and the lower limit counter (S303), process F22 (S304), determining a count value of the upper limit counter (S305), determining a count value of the lower limit counter (S306), decrementing the light amount value (S307), incrementing the light amount value (S308), outputting the light amount information (S309), and the like.

Setting an initial value of the light amount (S301): In advance of a starting of operation of the ToF system 2, the processing unit 8 sets an initial value of the light amount to the light emitter 4. Thus, in the ToF system 2, the comparison is executed since the initial value, and the light amount is optimally controlled to the object 14.

Controlling the light amount (S302): The processing unit 8 controls the light amount of the light emitter 4 by the light amount control part 10 with the light amount information.

Initializing the upper limit counter and the lower limit counter (S303): Initializing of the upper limit counter and the lower limit counter is executed, it proceeds to S304, and process F22 is executed.

Process F22 (S304): In process F22, the signal amount information is acquired from the selected frames to execute the acquisition processing of the signal amount information to all the frames. Processing after process F22 is explained first, and processing details of process F22 is described later.

Determining a count value of the upper limit counter (S305): The processing unit 8 that passed through process F22 determines the count value of the upper limit counter. When the count value>a rated value (NO of S305), it proceeds to S307, and when the count value≤the rated value (YES of S305), it proceeds to S306.

Determining a count value of the lower limit counter (S306): When the count value≤the rated value (YES of S305), the processing unit 8 determines the count value of the lower limit counter (S306). When the count value>a rated value (NO of S306), it proceeds to S308, and when the count value≤the rated value (YES of S306), it proceeds to S303.

Decrementing the light amount value (S307): When the count value>the rated value (NO of S305), the processing unit 8 decrements the light amount value and decrease the light amount because the light amount is excess and out of proper range.

Incrementing the light amount value (S308): When the count value>the rated value (NO of S306), the processing unit 8 increments the light amount value and increases the light amount because the light amount is too little and out of proper range.

Outputting the light amount information (S309): The processing unit 8 outputs the light amount information that represents the light amount increased or decreased, and inputs it into the light amount control part 10. Thus, the light amount control part 10 controls the light amount of the light emitter 4 with the light amount information.

### <Processing in Process F22 (S304)>

Process F22 (S304) includes emitting light by the light emitter 4 (S401), receiving the reflected light Lr (S402), frame output of the light receiver 6 (S403), frame input into the processing unit 8 (S404), extracting selected areas (S405), process F23 (S406), process F24 (S407), outputting the signal amount information (S408), and the like.

Emitting light by the light emitter 4 (S401): The processing unit 8 makes the light emitter 4 emit the light under control by the light amount control part 10. The light amount of the light emitter 4 is controlled by the light amount information acquired in process F21. Thereby, the light Li is applied to the object 14.

Receiving the reflected light Lr (S402): When the light Li is applied, the reflected light Lr is acquired from the object 14, and the light receiver 6 receives the reflected light Lr. Consequently, the received light output of the reflected light Lr is acquired in the light receiver 6.

Frame output of the light receiver 6 (S403): Frame output that represents the received light output is acquired in the light receiver 6.

Frame input into the processing unit 8 (S404): The frame output is input into the processing unit 8 from the light receiver 6.

Extracting selected areas (S405): The processing unit 8 extracts selected areas from the frame input of all the pixels input from the light receiver 6.

Process F23 (S406): It proceeds to process F23 after S405. In process F23, the comparison is executed for each pixel of the selected areas extracted by the processing unit 8, and the comparison is executed to all the pixel determinations.

Process F24 (S407): Process F24 is included in process F23, and when it goes into process F23, process F24 is executed. In process F24, a comparison is executed for each group including a plurality of pixels, and this comparison processing is executed to all the groups. When process F24 is completed, it proceeds to process F23.

Outputting the signal amount information (S408): When process F23 is completed, the processing unit 8 outputs the signal amount information and provides the signal amount information for the operation part 12.

### <Processing in Process F24 (S407)>

Process F24 includes comparing the luminance value with the upper limit threshold (S501), incrementing the upper limit counter (S502), comparing the luminance value with the lower limit threshold (S503), and incrementing the lower limit counter (S504).

Comparing the luminance value with the upper limit threshold (S501): The processing unit 8 compares the luminance value with the upper limit threshold, when the luminance value>the upper limit threshold (NO of S501), it proceeds to a processing of S502, and when the luminance value≤the upper limit threshold (YES of S501), it proceeds to a processing of S503.

Incrementing the upper limit counter (S502): When the luminance value>the upper limit threshold (NO of S501), the processing unit 8 incrementing the upper limit counter and increases the count value.

Comparing the luminance value with the lower limit threshold (S503): The processing unit 8 compares the luminance value with the lower limit threshold, when the luminance value<the lower limit threshold (NO of S503), it proceeds to a processing of S504, and when the luminance value≥the lower limit threshold (YES of S503), a processing of process F24 is ended.

Incrementing the lower limit counter (S504): When the luminance value<the lower limit threshold (NO of S503), the processing unit 8 increments the lower limit counter and increases the count value.

It proceeds from comparing each group in process F24 (S407) to process F23 (S406), and proceeds through comparing each pixel in process F23 to process F22.

When process F22 is ended, it proceeds to the processes of S305 to S309 of process F21 as described above, and ends this processing procedure.

According to this processing procedure, similarly to the second embodiment, the light amount information is increased or decreased according to the luminance value acquired from the reflected light Lr, and an optimization of the light amount of the light emitter 4 is attained.

### <Effect of Third Embodiment>

According to the third embodiment, the light amount of the light emitter 4 can be controlled to a predetermined value or a predetermined proper value range by using the count value of the counter counting the luminance value that represents the signal amount information acquired from the reflected light Lr and is less than the lower limit threshold or more than the upper limit threshold, so that the accuracy of the distance information can be raised.

### Fourth Embodiment

A ToF apparatus according to the fourth embodiment can be realized by having the ToF system 2 as described above within a case. Since apparatus configurations of the ToF apparatus are common in the ToF system 2 and a method and a program are similar to the methods and programs as described above, their explanations are omitted.

### <Effect of Fourth Embodiment>

According to the fourth embodiment, any of the following effects can be acquired.

(1) The same effects as the first embodiment to the third embodiment are acquired.

(2) The ToF apparatus including the ToF system 2 can be constituted, and, for example, a distance measuring apparatus or a camera can be realized.

### EXAMPLE

This example is for confirming how the distance between the object 14 and the ToF system 2 influences the distance information acquired from ToF system 2.

In the example, a gate for short distance, a gate for long distance, and a gate for eliminating disturbance by ambient light are installed as means for treating the received light output of the reflected light Lr and treat the received light output of the reflected light Lr.

Signal amount information is information acquired by measuring and quantifying characteristics of the reflected light Lr received by the light receiver 6. For example, when the light intensity of the reflected light Lr is measured in the light receiver 6, the luminance value of the reflected light Lr is output in the light receiver 6. Thus, in the example, the luminance value included in the received light output of the light receiver 6 is treated as the signal amount information.

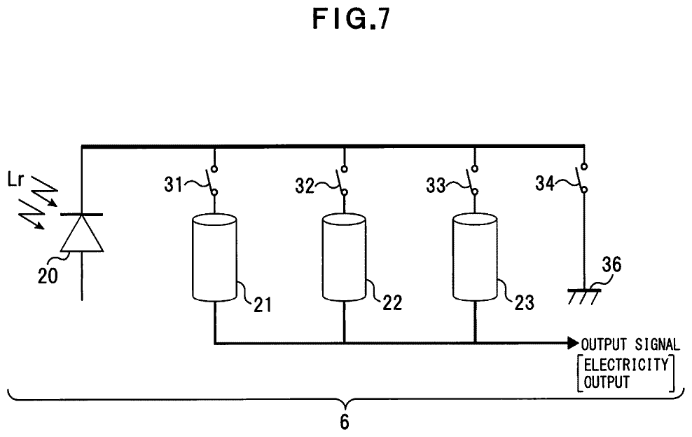

FIG. 7 illustrates an example of a light receiver 6 according to the example. The light receiver 6 shown in FIG. 7 is an example, and the present disclosure is not limited to this constitution.

The light receiver 6 includes a light receiving element 20 for receiving the reflected light Lr from the object 14. The light receiving element 20 receives light from ambience surrounding the object 14 (ambient light) as well as the reflected light Lr.

When the light receiving element 20 receives the ambient light, a capacitor 21 stores electricity acquired from the light receiving element 20 therein.

When the light receiving element 20 receives the reflected light Lr from the object 14 that is in a short distance, in which arrival time of light is short, a capacitor 22 stores electricity acquired by the light receiving element 20 therein.

When the light receiving element 20 receives the reflected light Lr from the object 14 that is in a long distance, in which arrival time of light is long, a capacitor 23 stores electricity acquired by the light receiving element 20 therein.

A gate 31 sets up storage time to the capacitor 21.

A gate 32 sets up storage time to the capacitor 22.

A gate 33 sets up storage time to the capacitor 23.

A drain gate 34 sets up a work timing for removing unnecessary electricity for distance measurement from the received light output of the light receiving element 20.

Cathode of the light receiving element 20 is connected to the capacitor 21 through the gate 31, is connected to the capacitor 22 through the gate 32, is connected to the capacitor 23 through the gate 33, and is connected to a reference potential point 36 (hereinafter called “drain 36”) through the drain gate 34.

### <Light Receiving Processing>

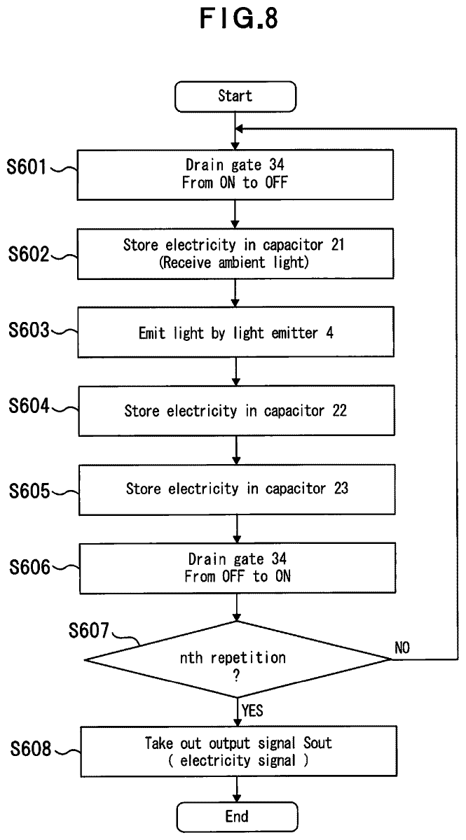

FIG. 8 illustrates a processing procedure at the time of an acquisition of the distance information by the light receiver 6. The processing procedure is an example of a control method of the ToF system or the ToF apparatus of the present disclosure or program thereof.

When acquiring the distance information, the drain gate 34 is changed from ON status (continuity status) to OFF status (non-continuity status) (S601), and the light receiving element 20 is set in a receiving preparatory state.

The continuity of the gate 31 is carried out before emission of the light emitter 4 and is cut at a predetermined timing. The electricity acquired by the light receiving element 20 during this continuity period is stored in the capacitor 21 (S602). Thereby, the electricity acquired by the light receiving element 20 due to reception of the ambient light is stored in the capacitor 21.

The light emitter 4 is made to emit light (S603), the light Li is applied to the object 14.

The continuity of the gate 32 is carried out and is cut at a predetermined timing. The electricity acquired by the light receiving element 20 during this continuity period is stored in the capacitor 22 (S604).

The continuity of the gate 33 is carried out and is cut at a predetermined timing. The electricity acquired by the light receiving element 20 during this continuity period is stored in the capacitor 23 (S605).

The drain gate 34 is changed from OFF status to ON status (S606) to discharge electricity by light reception of the light receiving element 20 into the drain 36.

A series of the processing (S601-S606) is repeated n times. A repeat count of the series is checked (S607), and when a repetition of the series of the processing reaches n times (YES of S607), taking-out of the output signal Sout (electricity signal) is executed (S608). The output signal Sout corresponds to the signal amount information as described above.

### <Work Timing of Receiving Processing>

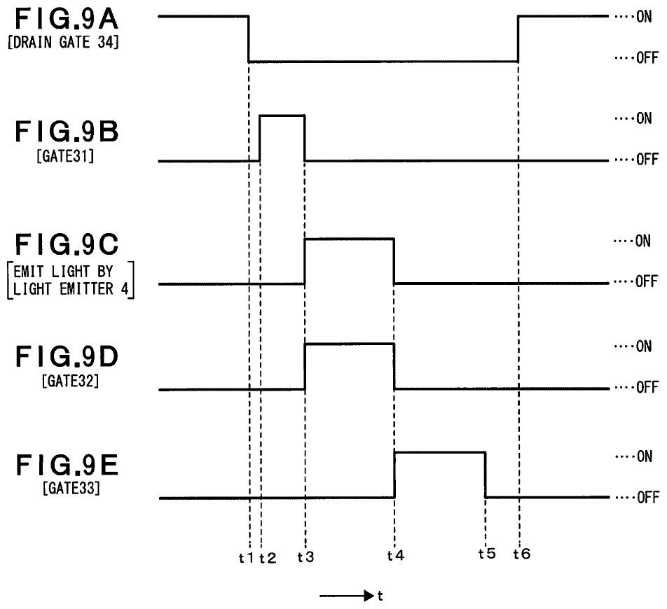

FIG. 9A illustrates timing of ON and OFF of the drain gate 34. The drain gate 34 is changed from ON status (continuity status) to OFF status (non-continuity status) at time t1 and is changed from OFF status to ON status at time t6. That is, a section from time t1 to time t6 is OFF section of the drain gate 34.

FIG. 9B illustrates timing of ON and OFF of the gate 31. The gate 31 is changed from OFF status to ON status at time t2 right after time t1 and is changed from ON status to OFF status at time t3. That is, a continuity of the gate 31 is carried out during a section from time t2 to time t3. The section from time t2 to time t3 is a light reception period of the ambient light.

FIG. 9C illustrates light emission timing of the light emitter 4. The light emitter 4 starts to emit the light at time t3 and turns off the light at time t4. A section from time t3 to time t4 is a light emission period.

FIG. 9D illustrates timing of ON and OFF of the gate 32. The gate 32 is changed from OFF status to ON status at time t3 and is changed from ON status to OFF status at time t4. That is, a continuity of the gate 32 is carried out during a section from time t3 to time t4. The section from time t3 to time t4 is a light reception period of the reflected light Lr to the object 14 in the short distance.

FIG. 9E illustrates timing of ON and OFF of the gate 33. The gate 33 is changed from OFF status to ON status at time t4 and is changed from ON status to OFF status at time t5. That is, a continuity of the gate 33 is carried out during a section from time t4 to time t5. The section from time t4 to time t5 is a light reception period of the reflected light Lr to the object 14 in the long distance.

<Case where Object 14 Exist in Short Distance>

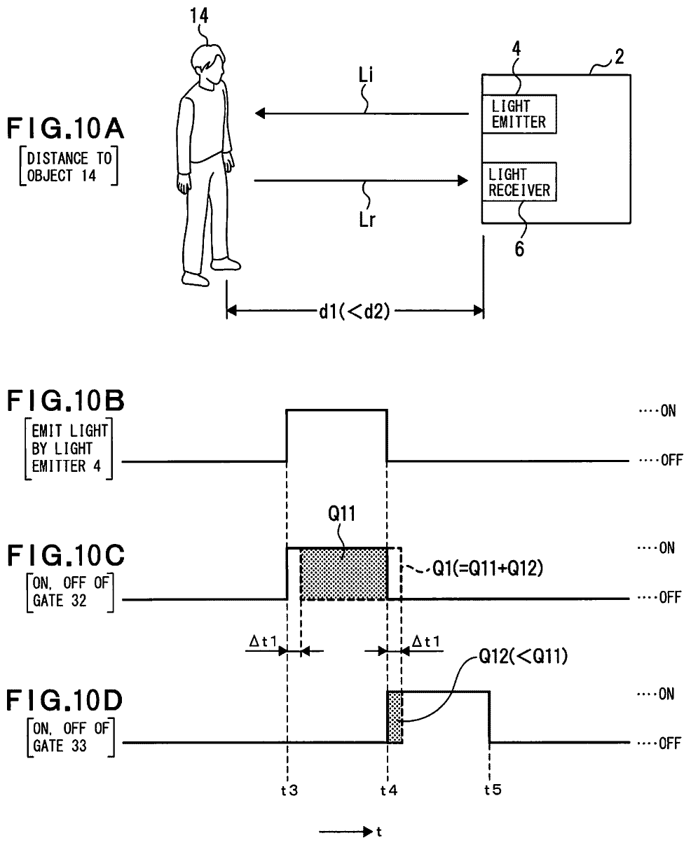

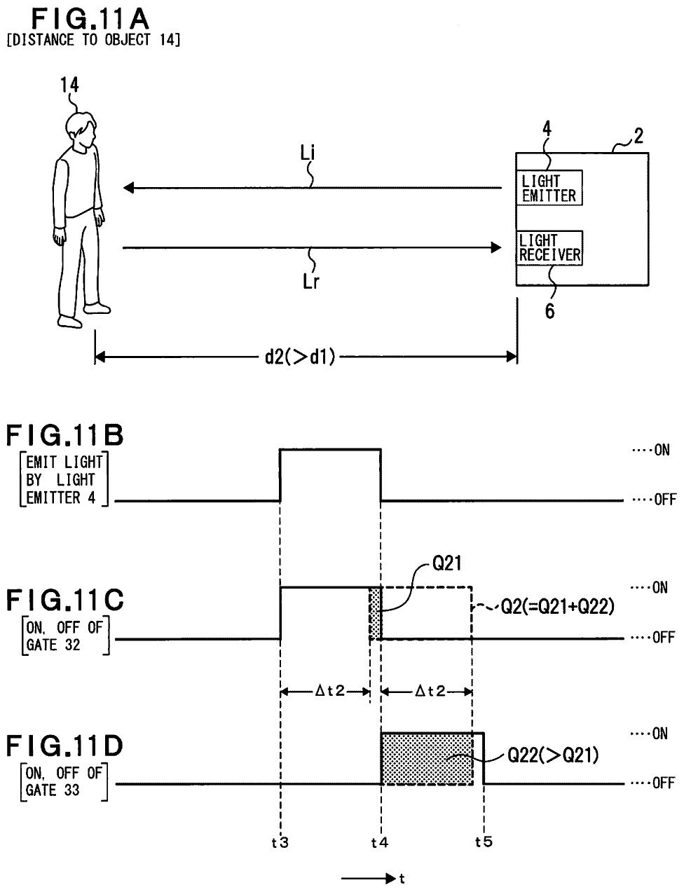

FIG. 10A illustrates a distance d1 between the object 14 and the ToF system 2 (the distance d1 is the short distance).

FIG. 10B illustrates the light emission period of the light emitter 4 from time t3 to time t4. The light Li is applied to the object 14 during this light emission period. Assuming that electricity Q1 as the received light output is acquired from the light receiving element 20 receiving the reflected light Lr from the object 14.

FIG. 10C illustrates a continuity period of the gate 32 from time t3 to time t4. According to the distance d1 between the object 14 and the light receiver 6, delay time Δt1 of light reception of the reflected light Lr arises. Consequently, electricity from the light receiving element 20 is stored in the capacitor 22 during a period from time (t3+Δt1), which is after only delay time Δt1 from time t3, to time t4. This electricity is treated as Q11.

FIG. 10D illustrates a continuity period of the gate 33 from time t4 to time t5. Electricity from the light receiving element 20 is stored in the capacitor 23 during a period from time t4 to time (t4+Δt1), which is after only delay time Δt1 from time t4. This electricity is treated as Q12.

Thus, the electricity Q11 having most of the electricity Q1 produced by the light receiving element 20 is stored in the capacitor 22, and the electricity Q12 stored in the capacitor 23 is little. That is, the distance to the object 14 is proportional to storage amounts (signal amounts) of the electricity Q11 stored in the capacitor 22 and the electricity Q12 stored in the capacitor 23. Thus, it is found from large or small of the electricity Q11 and Q12 that the distance to the object 14 is the short distance.

<Case where Object 14 Exist in Long Distance>

FIG. 11A illustrates a distance d2 between the object 14 and the ToF system 2 (the distance d2 is the long distance).

FIG. 11B illustrates the light emission period of the light emitter 4 from time t3 to time t4. The light Li is applied to the object 14 during this light emission period. Assuming that electricity Q2 (<Q1) as the received light output is acquired from the light receiving element 20 receiving the reflected light Lr from the object 14.

FIG. 11C illustrates a continuity period of the gate 32 from time t3 to time t4. According to the distance d2 between the object 14 and the light receiver 6, delay time Δt2 (>Δt1) of light reception of the reflected light Lr arises. Consequently, electricity from the light receiving element 20 is stored in the capacitor 22 during a period from time (t3+Δt2), which is after only delay time Δt2 from time t3, to time t4. This electricity is treated as Q21.

FIG. 11D illustrates a continuity period of the gate 33 from time t4 to time t5. Electricity from the light receiving element 20 is stored in the capacitor 23 during a period from time t4 to time (t4+Δt2), which is after only delay time Δt2 from time t4. This electricity is treated as Q22.

Thus, the electricity Q22 having most of the electricity Q2 produced by the light receiving element 20 is stored in the capacitor 23, and the electricity Q21 stored in the capacitor 22 is little. That is, the distance to the object 14 is proportional to storage amounts (signal amounts) of the electricity Q21 stored in the capacitor 22 and the electricity Q22 stored in the capacitor 23. Thus, it is found from large or small of the electricity Q21 and Q22 that the distance to the object 14 is the long distance.

<Relationship between Distance to Object 14 and Received Light Amount>

The received light amount of the light receiver 6 receiving the reflected light Lr is dependent on the optical density of the reflected light Lr. It can be considered seemingly that the optical density is density of light emitted by the object 14 as a light source. If the total light amount is denoted by P, the optical density is decreased in proportion to the square of distance d. If optical density at a point a certain distance away from the object 14 is denoted by Pd, Pd can be expressed as formula 2.

Pd=P/(4πd²) (Formula 2)

It is possible to execute a distance operation from a ratio of storage of electricity in the above-mentioned way. However, since the optical density varies with distance d, the accuracy of the distance information may be affected. That is, in case with the short distance, Pd is large, and the received light output of the light receiver 6 may be saturated. In the case with the long distance, Pd is small, and a signal-to-noise ratio may become worse. Thus, in a selected distance d, the light amount of the light emitter 4 may be controlled to acquire the suitable optical density Pd.

In the example, if the amount of electricity is the signal amount, the amount of output signal of the capacitor 21 for measuring the ambient light is denoted by S1, the amount of output signal of the capacitor 22 is denoted by S2, and the amount of output signal of the capacitor 23 is denoted by S3, these total signal amounts (intensity) can be expressed as formula 3.

Intensity=(S2−S1)+(S3−S1) Formula 3

In formula 3, the (S2−S1) represents an amount of a pure signal given by subtracting the amount S1 of the output signal of the capacitor 21 (that is, ambient noise component) from the amount S2 of the output signal of the capacitor 22. The (S3−S1) represents an amount of a pure signal given by subtracting the amount S1 of the output signal of the capacitor 21 from the amount S3 of the output signal of the capacitor 23. Thus, the intensity is signal amount information in which the ambient noise component is excepted, and represents an information amount in which the ambient noise component is excepted by offsetting.

A desired value that is 2500 was set to the intensity. The desired value is an assumption value that is about 60% of signal amount of the 12 bits (2 to the power of twelve=4096) as a value with which the light receiver 6 is not in saturation or a low signal-to-noise ratio state.

In this example, a personal computer (PC) was set outside the ToF system 2, control commands were transmitted to the light amount control part 10 from the PC, and the intensity and the distance information were acquired when the light amount of the light emitter 4 was set to any of three grades “large”, “middle” and “small”. The result is shown in table 1.

TABLE 1
Distance to object 14: 500[mm]

| Light amount of | Intensity | |
|---|---|---|
| light emitter 4 | (Total signal amount) | Distance information |
| Large | 4025 | 576[mm] |
| Middle | 2531 | 496[mm] |
| Small | 652 | 148[mm] |

In this example, when the distance to the object 14 was set to a desired value that is 500 mm and the light amount of the light emitter 4 was set to the “large”, acquired intensity was 4025. The distance information found from this intensity was 576 mm and deviated sharply from the desired value. Also, acquired intensity was 652 when the light amount of the light emitter 4 was set to the “small”. The distance information found from this intensity was 148 mm and deviated sharply from the desired value.

In contrast, acquired intensity was 2531 when the light amount of the light emitter 4 was set to the “middle”. The distance information found from this intensity was 496 mm and the desired value was acquired mostly.

As is clear from this example, when the light amount was set to the large or small without the control of the signal amount information, the intensity had the signal amount sharply larger or smaller than the desired value, and the distance information deviated sharply from a real distance to the object 14.

Thus, it is confirmed that when the signal amount information acquired by the light receiver 6 is controlled within the range between the LimL and LimU, the signal amount can be made proper and properness of the distance information can be attained. Moreover, it is confirmed that when the LimL and LimU are set according to the measurement distance to the object 14, the signal amount can be made more proper and increasing the accuracy of the distance information can be realized.

### Other Embodiments

The following modifications are included in the present disclosure.

(1) In the above embodiments or the example, the amount of electric current made to flow into the light-emitting device of the light emitter 4 is exemplified as a parameter by which the light amount acquired by the light emitter 4 is controlled, but a parameter such as an electrical amount other than the amount of electric current may be used.

(2) The energy density (that is, luminous flux density) of the light Li applied to the object 14 from the light emitter 4 may be controlled.

(3) Wavelength of the light Li may be controlled.

(4) Diffusion amount of the light Li may be controlled. It is possible to adjust actuating current for the light-emitting device installed in the light emitter 4 and control the diffusion amount of the light Li. Moreover, when a diaphragm is provided for the light emitter 4, it is possible to control the diffusion amount of floodlight from the light emitter 4 to the object 14 by the diaphragm. Moreover, when the light emitter 4 includes a plurality of light-emitting devices, the number of lighting of the light-emitting devices may be controlled. Thus, the light emitter 4 may include one light-emitting device or the light-emitting devices, the light amount control part 10 controls the amount of electric current made to flow into the light-emitting device(s) or controls the number of the light-emitting device(s) on emitting, and the signal amount information acquired from the received light output of the light receiver 6 can be controlled.

In accordance with aspects of the embodiments or the examples, a ToF system, a control method of a ToF system, a computer readable recording medium, or a ToF apparatus is as follows.

A ToF system is configured to apply light to an object and find distance information by receiving reflected light from the object and includes a light source portion configured to apply the light to the object; a light receiver configured to receive the reflected light from the object; an information processing unit configured to acquire signal amount information from a received light output of the light receiver and calculate light amount information for making the signal amount information arise at a predetermined value or within a predetermined range of a lower limit threshold to an upper limit threshold; and a light amount control part configured to control a light amount of the light source portion using the light amount information.

In the ToF system, the information processing unit may be configured to compare an average of all or a part of the signal amount information with the lower limit threshold or the upper limit threshold to generate the light amount information.

In the ToF system, the information processing unit may be configured to select a specific object area or an object frame from pixels that represent the received light output of the light receiver to calculate the average of the signal amount information.

In the ToF system, the light source portion may include one light-emitting device or a plurality of light-emitting devices, and the light amount control part may be configured to control an amount of electric current made to flow into the light-emitting device or the light-emitting devices or control a number of the light-emitting devices on emitting.

A control method of a ToF system configured to apply light to an object and find distance information by receiving reflected light from the object includes, by a light source portion, emitting the light and applying the light to the object; by a light receiver, receiving the reflected light of the object; by an information processing unit, acquiring signal amount information from a received light output of the light receiver and calculating light amount information for making the signal amount information arise at a predetermined value or within a predetermined range of a lower limit threshold to an upper limit threshold; and by a light amount control part, controlling a light amount of the light source portion using the light amount information.

A computer readable recording medium stores a program for causing a computer to execute applying light to an object from a light source portion; acquiring signal amount information from a received light output of a light receiver receiving reflected light of the object and calculating light amount information for making the signal amount information arise at a predetermined value or within a predetermined range of a lower limit threshold to an upper limit threshold; controlling a light amount of the light source portion using the light amount information.

A ToF apparatus is configured to apply light to an object and find distance information by receiving reflected light from the object and includes a light source portion configured to apply the light to the object; a light receiver configured to receive the reflected light from the object; an information processing unit configured to acquire signal amount information from a received light output of the light receiver and calculate light amount information for making the signal amount information arise at a predetermined value or within a predetermined range of a lower limit threshold to an upper limit threshold; and a light amount control part configured to control a light amount of the light source portion using the light amount information.

According to aspects of the embodiments or the examples, any of the following effects can be obtained.

(1) The light is applied to the object from the light emitter, the light receiver receives the reflected light from the object, the signal amount information of the reflected light is acquired from the received light output acquired by the light receiver, and the amount of the light applied to the object can be controlled so that the signal amount information is acquired from the lower limit threshold to the upper limit threshold inclusive.

(2) Since the light amount of the light emitter is controlled so that the signal amount information of the reflected light acquired by the light receiver is acquired from the lower limit threshold to the upper limit threshold inclusive, the signal amount information of the reflected light can be made proper, and a received light amount of the light receiver is not saturated or does not fall a low signal-to-noise ratio state because of a shortage of the received light amount. The accuracy of the distance information calculated from the signal amount can be improved, and reliability of the distance information can be improved.

(3) Since the information processed is made proper when calculating the distance information to the object, the load of an information processing can be reduced.

As described above, the most preferred embodiment, embodiments, and examples of the present disclosure have been described. The present disclosure is not limited to the above description. Various modifications and changes can be made by those skilled in the art based on technical contents described in the claims or disclosed in the specification. It goes without saying that such modifications and changes are included in the scope of the present disclosure.

The light is applied to the object from the light emitter, the light receiver receives the reflected light from the object, the signal amount information of the reflected light is acquired from the received light output acquired by the light receiver, and the amount of the light applied to the object can be controlled so that the signal amount information is acquired from the lower limit threshold to the upper limit threshold inclusive. The light amount of the reflected light received by the light receiver can be made proper, and the accuracy of the distance information acquired from the ToF system or the ToF apparatus can be improved.

What is claimed is:

1. A ToF system configured to apply light to an object and find distance information by receiving reflected light from the object, the ToF system comprising:
a light source portion configured to apply the light to the object;
a light receiver configured to receive the reflected light from the object;
an information processing unit configured to acquire signal amount information from a received light output of the light receiver and calculate light amount information for making the signal amount information arise at a predetermined value or within a predetermined range of a lower limit threshold to an upper limit threshold; and
a light amount control part configured to control a light amount of the light source portion using the light amount information.

2. The ToF system according to claim 1, wherein the information processing unit is configured to compare an average of all or a part of the signal amount information with the lower limit threshold or the upper limit threshold to generate the light amount information.

3. The ToF system according to claim 2, wherein the information processing unit is configured to select a specific object area or an object frame from pixels that represent the received light output of the light receiver to calculate the average of the signal amount information.

4. The ToF system according to claim 1, wherein
the light source portion includes one light-emitting device or a plurality of light-emitting devices, and
the light amount control part is configured to control an amount of electric current made to flow into the light-emitting device or the light-emitting devices or control a number of the light-emitting devices on emitting.

5. The ToF system according to claim 2, wherein
the light source portion includes one light-emitting device or a plurality of light-emitting devices, and
the light amount control part is configured to control an amount of electric current made to flow into the light-emitting device or the light-emitting devices or control a number of the light-emitting devices on emitting.

6. A control method of a ToF system configured to apply light to an object and find distance information by receiving reflected light from the object, the control method comprising:
by a light source portion, emitting the light and applying the light to the object;
by a light receiver, receiving the reflected light of the object;
by an information processing unit, acquiring signal amount information from a received light output of the light receiver and calculating light amount information for making the signal amount information arise at a predetermined value or within a predetermined range of a lower limit threshold to an upper limit threshold; and
by a light amount control part, controlling a light amount of the light source portion using the light amount information.

7. A computer readable recording medium storing a program for causing a computer to execute:
applying light to an object from a light source portion;
acquiring signal amount information from a received light output of a light receiver receiving reflected light of the object and calculating light amount information for making the signal amount information arise at a predetermined value or within a predetermined range of a lower limit threshold to an upper limit threshold;
controlling a light amount of the light source portion using the light amount information.

8. A ToF apparatus configured to apply light to an object and find distance information by receiving reflected light from the object, the ToF apparatus comprising:
a light source portion configured to apply the light to the object;
a light receiver configured to receive the reflected light from the object;
an information processing unit configured to acquire signal amount information from a received light output of the light receiver and calculate light amount information for making the signal amount information arise at a predetermined value or within a predetermined range of a lower limit threshold to an upper limit threshold; and
a light amount control part configured to control a light amount of the light source portion using the light amount information.
